(19) United States
(12) Patent Application Publication
(10) Pub. No.: US 2025/0361116 A1
(43) Pub. Date: Nov. 27, 2025

(54) Cable Core Separation System

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Roberto Francisco-Yi Lu, Middletown, PA (US)

(73) Assignees: TE Connectivity Solutions GmbH, Schaffhausen (CH); Tyco Electronics (Shanghai) Co., Ltd., Shanghai (CN)

(21) Appl. No.: 19/214,112

(22) Filed: May 21, 2025

(30) Foreign Application Priority Data
May 21, 2024 (CN) 202410636573.7

(51) Int. Cl. B65H 73/00

(52) U.S. Cl. CPC B65H 73/00

(57) ABSTRACT

The cable core separation system includes a gripper moving device and a gripper. The gripper moving device includes a mounting plate, a slide rail, a first slider, a second slider, a connecting member, and a driving mechanism. The slide rail is fixed on the mounting plate and has a first slide rail and a second slide rail vertically connected to a front end of the first slide rail. The first slider is installed on the slide rail and moves along the slide rail. The second slider is installed on the slide rail in front of the first slider and moves along the slide rail. The connecting member has two ends each rotatably connected to one of the first slider and the second slider. The driving mechanism is installed on the mounting plate and connected to the first slider. The driving mechanism drives the first slider to move along the first slide rail. The gripper installed on the second slider grips and separates a core wire of a cable. The second slider moves between the first slide rail and the second slide rail under a drive of the first slider such that the gripper is switched between a first state parallel to an axial direction of the cable and a second state parallel to a radial direction of the cable.

### CROSS-REFERENCE TO RELATED APPLICATION

This application claims the benefit of the filing date under 35 U.S.C. § 119 (a)-(d) of Chinese Patent Application No. CN202410636573.7 filed on May 21, 2024.

### FIELD OF THE INVENTION

The present invention relates to a separation system and, more particularly, to a cable core separation system.

### BACKGROUND OF THE INVENTION

In the prior art, for a cable containing multiple core wires, it is necessary to separate and clamp each core wire separately during the assembly process in order to ensure sufficient positioning accuracy in subsequent processes. In the prior art, it is common to manually separate multiple core wires of the cable one by one. However, the efficiency of manually separating the core wires is very low and cannot meet the requirements of automated production lines.

### SUMMARY OF THE INVENTION

The cable core separation system includes a gripper moving device and a gripper. The gripper moving device includes a mounting plate, a slide rail, a first slider, a second slider, a connecting member, and a driving mechanism. The slide rail is fixed on the mounting plate and has a first slide rail and a second slide rail vertically connected to a front end of the first slide rail. The first slider is installed on the slide rail and moves along the slide rail. The second slider is installed on the slide rail in front of the first slider and moves along the slide rail. The connecting member has two ends each rotatably connected to one of the first slider and the second slider. The driving mechanism is installed on the mounting plate and connected to the first slider. The driving mechanism drives the first slider to move along the first slide rail. The gripper installed on the second slider grips and separates a core wire of a cable. The second slider moves between the first slide rail and the second slide rail under a drive of the first slider such that the gripper is switched between a first state parallel to an axial direction of the cable and a second state parallel to a radial direction of the cable.

### BRIEF DESCRIPTION OF DRAWINGS

The invention will now be described by way of example with reference to the accompanying figures, of which:

FIG. 1 is a perspective view of a cable core separation system according to an exemplary embodiment;

FIG. 2 is a perspective view of a gripper moving device of the cable core separation system of FIG. 1; and

FIG. 3 is a perspective front side view of the cable core separation system of FIG. 1.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

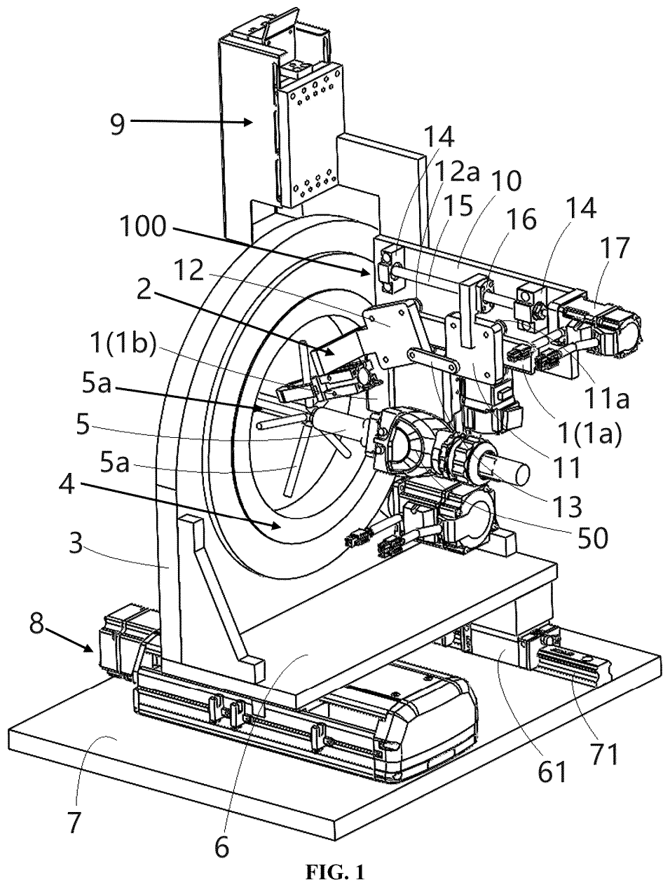

An exemplary embodiment of a cable core separation system is now described with reference to FIGS. 1-3. As shown in FIG. 1, the cable core separation system comprises a gripper moving device 100 and a gripper 2.

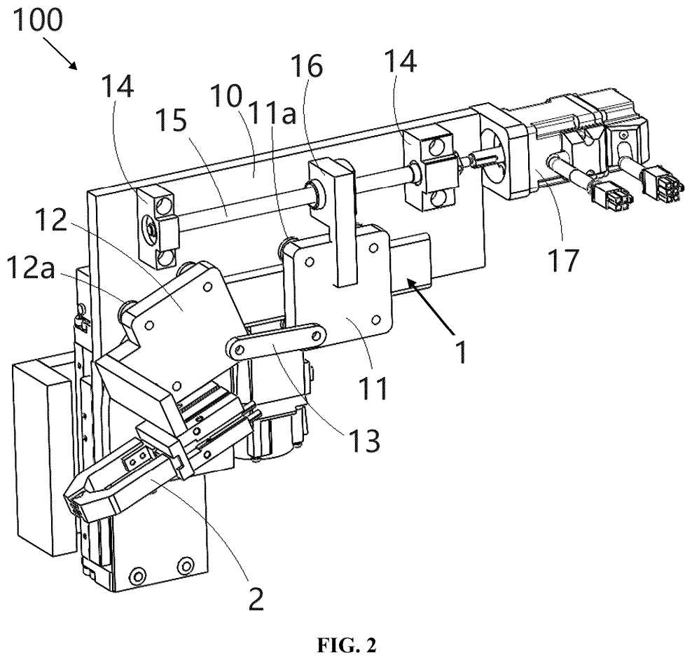

As shown in FIGS. 1-2, the gripper moving device 100 includes: a mounting plate 10, a slide rail 1, a first slider 11, a second slider 12, a connecting member 13, and a driving mechanism. The slide rail 1 is fixed on the mounting plate 10 and includes a first slide rail 1a and a second slide rail 1b vertically connected to the front end of the first slide rail 1a. The first slider 11 is installed on the slide rail 1 to move along the slide rail 1. The second slider 12 is located in front of the first slider 11 and is installed on the slide rail 1 to move along the slide rail 1. Both ends of the connecting member 13 are rotatably connected to the second slider 12 and the first slider 11, respectively. The driving mechanism is installed on the mounting plate 10 and connected to the first slider 11, and is used to drive the first slider 11 to move along the first slide rail 1a. The gripper 2 is installed on the second slider 12 for gripping and separating the core wire 5a of the cable 5. The second slider 12 is adapted to move between the first slide rail 1a and the second slide rail 1b under the drive of the first slider 11, so that the gripper 2 installed on the second slider 12 can be switched between a first state parallel to the axial direction of the cable 5 and a second state parallel to the radial direction of the cable 5.

As shown in FIG. 1, the gripper 2 grips the unseparated core wire 5a of cable 5 when the gripper 2 is in the second state. After the gripper 2 grips the unseparated core wire 5a, the gripper 2 is switched from the second state to the first state, in order to bend the gripped core wire 5a from an initial position parallel to the axial direction of cable 5 to a separation position parallel to the radial direction of cable 5 (that is, perpendicular to the axial direction of cable 5).

The driving mechanism is used to drive the first slider 11 to move along the first slide rail 1a between a first position and a second position. When the first slider 11 is in the first position, the second slider 12 is moved onto the first slide rail 1a, causing the gripper 2 to be in the first state. When the first slider 11 is in the second position, the second slider 12 is moved onto the second slide rail 1b, causing the gripper 2 to be in the second state.

When the driving mechanism drives the first slider 11 to move forward along the first slide rail 1a from the first position to the second position, the first slider 11 drives the second slider 12 to switch from the first state to the second state. When the driving mechanism drives the first slider 11 to move backwards along the first slide rail 1a from the second position to the first position, the first slider 11 drives the second slider 12 to switch from the second state to the first state.

As shown in FIGS. 1-2, the driving mechanism includes two mounting blocks 14, a lead screw 15, a nut 16, and a first servo motor 17. The two mounting blocks 14 are fixed to the mounting plate 10. The two ends of the lead screw 15 are rotatably mounted on the two mounting blocks 14. The axis of the lead screw 15 is parallel to the first slide rail 1a. The nut 16 is threaded with the lead screw 15 and connected to the first slider 11. The first servo motor 17 is connected to one end of the lead screw 15 and is used to drive the lead screw 15 to rotate. When the first servo motor 17 drives the lead screw 15 to rotate, the nut 16 is moved along the axis of the lead screw 15 and drives the first slider 11 to move along the first slide rail 1a.

As shown in FIGS. 1-2, the first slider 11 has multiple pairs of first rollers 11a, which are rotatably mounted on both sides of the first slider 11 and rollable on both sides of the slide rail 1, allowing the first slider 11 to move along the slide rail 1. As further shown in FIGS. 1-2, the second slider 12 has multiple pairs of second rollers 12a, which are rotatably mounted on both sides of the second slider 12 and rollable on both sides of the slide rail 1, allowing the second slider 12 to move along the slide rail 1.

As shown in FIG. 1, the cable core separation system further comprises a support frame 3 and a rotating ring 4. The rotating ring 4 is rotatably installed on the support frame 3 so that it can rotate around its central axis. The front end of the mounting plate 10 is fixed to the rotating ring 4, so that the mounting plate 10 and the gripper 2 installed on the mounting plate 10 can be rotated to different orientations in the circumferential direction of the cable 5 along with the rotating ring 4.

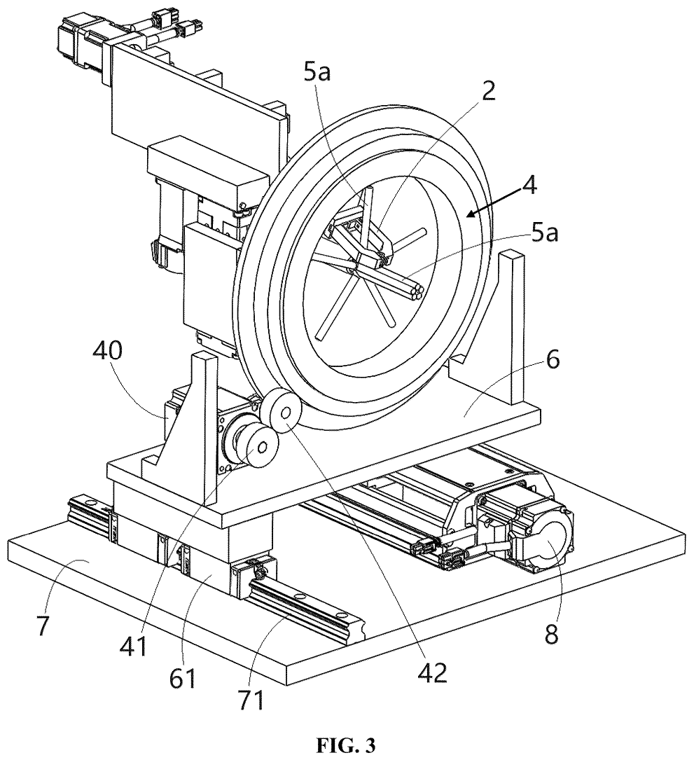

As shown in FIGS. 1 and 3, the cable 5 includes multiple core wires 5a. The multiple core wires 5a extend along the axial direction of the cable 5 and are located in different orientations in the circumferential direction of cable 5 when not separated. The rotating ring 4, as shown in FIGS. 1 and 3, is used to rotate the gripper 2 to different orientations, so that the gripper 2 can grip the core wires 5a located in different orientations in the circumferential direction of cable 5.

The cable core separation system further comprises a rotation drive mechanism, which is connected to the rotating ring 4 and used to drive the rotating ring 4 to rotate around its central axis. As shown in FIG. 3, the rotation drive mechanism includes a second servo motor 40, a driving wheel 41, and a transmission wheel 42. The driving wheel 41 is connected to the output shaft of the second servo motor 40. The transmission wheel 42 is engaged between the driving wheel 41 and the rotating ring 4. When the second servo motor 40 drives the aforementioned driving wheel 41 to rotate, the driving wheel 41 drives the rotating ring 4 to rotate through the transmission wheel 42.

As shown in FIG. 3, the driving wheel 41 and the transmission wheel 42 are gears. As further shown in FIG. 3, an external gear that meshes with the transmission wheel 42 is formed on the outer circumferential surface of the rotating ring 4. In another exemplary embodiment, the driving wheel 41 and the transmission wheel 42 are friction wheels. In the another exemplary embodiment, the driving wheel 41 is in frictional engagement with the transmission wheel 42, and the transmission wheel 42 is in frictional engagement with the outer circumferential surface of the rotating ring 4.

As shown in FIGS. 1 and 3, the cable core separation system further comprises a fixed seat 7 and a movable seat 6. The movable seat 6 is mounted on the fixed seat 7 in a movable manner and can be moved along the axial direction of the cable 5. The support frame 3 and the rotation drive mechanism are installed on the movable seat 6 to be able to move along the axial direction of the cable 5 together with the movable seat 6.

As shown in FIGS. 1 and 3, a horizontal guide rail 71 extending along the axial direction of the cable 5 is fixed on the fixed seat 7, and a sliding block 61 is fixed on the bottom of the movable seat 6. The sliding block 61 is in sliding engagement with the horizontal guide rail 71, allowing the movable seat 6 to move along the horizontal guide rail 71.

As shown in FIGS. 1 and 3, the cable core separation system further comprises a horizon drive mechanism 8. The horizon drive mechanism 8 is installed on the fixed seat 7 and connected to the movable seat 6. The horizon drive mechanism 8 is for driving the movable seat 6 to move along the axial direction of the cable 5. The horizon drive mechanism 8 includes a linear electric cylinder. The actuator of the linear electric cylinder is connected to the movable seat 6 to drive the movable seat 6 to move along the axial direction of the cable 5. However, the present invention is not limited to the illustrated embodiment. For example, in another embodiment, the horizon drive mechanism 8 may include a cylinder, and the piston rod of the cylinder may be connected to the movable seat 6 to drive the movable seat 6 to move along the axial direction of the cable 5.

As shown in FIG. 1, the cable core separation system further comprises a cable clamp 50, which is fixed to the fixed seat 7 for clamping the cable 5. When the cable 5 is clamped onto the cable clamp 50, the cable 5 is centrally positioned in the rotating ring 4 such that the central axis of the cable 5 coincides with the central axis of the rotating ring 4.

When the movable seat 6 is moved along the axial direction of the cable 5, the gripper 2 is moved along the axial direction of the cable 5 together with the movable seat 6, so that the gripping position of the gripper 2 in the axial direction can be adjusted.

As shown in FIG. 1, the cable core separation system further includes an imaging device 9. The imaging device 9 is fixed to the mounting plate 10 and is directed radially towards the unseparated core wire 5a of the cable 5. The imaging device 9 captures images of the unseparated core wires 5a of the cable 5.

The cable core separation system further includes a core wire image processing device, a core wire pose recognition device, a gripping pose calculation device, and a gripper control device. The core wire image processing device is connected to the imaging device 9 for communication. The core wire image processing device is used to process the image of the unseparated core wires 5a of the cable 5 captured by the imaging device 9. The core wire pose recognition device calculates the circumferential orientation and axial position of the unseparated core wire 5a of cable 5 based on the processed image. The gripping pose calculation device calculates the gripping orientation and gripping position of the gripper 2 based on the identified orientation and position of the core wire 5a. The gripper control device controls the circumferential rotation of the rotating ring 4, the axial movement of the movable seat 6, and the movement of the gripper moving device 100 to move the gripper 2 to the gripping position and the gripping position.

When the gripper 2 is moved to the gripping position, the gripper 2 grips the unseparated core wire 5a of cable 5. After the gripper 2 grips the unseparated core wire 5a of the cable 5, the gripper control device controls the first slider 11 to move back along the slide rail 1, so as to bend the gripped core wire 5a from the initial position parallel to the axial direction of the cable 5 to the separation position parallel to the radial direction of the cable 5 through the gripper 2.

The cable core separation system is based on visual image recognition, combined with a flexible gripper 2, to achieve precise positioning, clamping, and separation of each core wire 5a of the cable 5, ensuring the overall coherence of the assembly process automation. The cable core separation system integrates visual recognition technology and automatic control system, achieving automatic separation of core wires 5a for multi-core cables 5. The cable core separation system comprehensively utilizes visual cameras and image processing technology to capture the pose of the core wires 5a through visual cameras, and uses image processing technology to identify and locate each core wire 5a, achieving precise positioning and pose analysis of the core wires 5a. The cable core separation system can achieve automatic clamping and separation of core wires 5a. Through the control system, the position and orientation of the gripper's gripper are automatically adjusted to achieve clamping and separation of core wires 5a, greatly improving production efficiency and accuracy. The gripper 2 of the cable core separation system can flip 90 degrees during movement and retract after clamping, allowing for smooth separation of the core wire 5a.

The cable core separation system has the following advantages: (1) improving production efficiency: the automated core wire separation process reduces the need for manual operation, improving the operational efficiency and production capacity of the production line; (2) high precision: by utilizing visual and automatic control systems, precise positioning and control of each core wire 5a can be achieved, ensuring the accuracy and stability of the separation process; (3) reducing labor intensity: the automated core wire separation process reduces the labor intensity and operational risks of workers, improving the safety and comfort of the production workshop. Consequently, in the aforementioned exemplary embodiments according to the present invention, the cable core separation system can achieve automatic separation of the core wires 5a of the multi-core cable 5, improve the separation efficiency of the core wires 5a, and is suitable for automated production lines.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A cable core separation system, comprising:
a gripper moving device including a mounting plate, a slide rail, a first slider, a second slider, a connecting member, and a driving mechanism, the slide rail is fixed on the mounting plate and has a first slide rail and a second slide rail vertically connected to a front end of the first slide rail, the first slider is installed on the slide rail and moves along the slide rail, the second slider is installed on the slide rail in front of the first slider and moves along the slide rail, the connecting member has two ends each rotatably connected to one of the first slider and the second slider, the driving mechanism is installed on the mounting plate and connected to the first slider, the driving mechanism drives the first slider to move along the first slide rail; and
a gripper installed on the second slider grips and separates a core wire of a cable, the second slider moves between the first slide rail and the second slide rail under a drive of the first slider such that the gripper is switched between a first state parallel to an axial direction of the cable and a second state parallel to a radial direction of the cable.

2. The cable core separation system of claim 1, wherein the gripper grips an unseparated core wire of the cable when in the second state and is switched from the second state to the first state after gripping the unseparated core wire, when switched from the second state to the first state the gripper bends the gripped core wire from an initial position parallel to the axial direction of the cable to a separation position parallel to the radial direction of the cable.

3. The cable core separation system of claim 2, wherein the driving mechanism drives the first slider to move along the first slide rail between a first position and a second position, the gripper is in the first state when the first slider is in the first position and the second slider is moved onto the first slide rail, the gripper is in the second state when the first slider is in the second position and the second slider is moved onto the second slide rail.

4. The cable core separation system of claim 3, wherein the first slider drives the second slider to switch the gripper from the first state to the second state when the driving mechanism drives the first slider to move forward along the first slide rail from the first position to the second position, and the first slider drives the second slider to switch the gripper from the second state to the first state when the driving mechanism drives the first slider to move backwards along the first slide rail from the second position to the first position.

5. The cable core separation system of claim 2, wherein the driving mechanism has two mounting blocks fixed to the mounting plate, a lead screw having both ends each rotatably mounted on one of the two mounting blocks and an axis parallel to the first slide rail, a nut threaded with the lead screw and connected to the first slider, and a first servo motor connected to one end of the lead screw, when the first servo motor drives the lead screw to rotate, the nut is moved along the axis of the lead screw and drives the first slider to move along the first slide rail.

6. The cable core separation system of claim 2, wherein the first slider has a plurality of pairs of first rollers rotatably mounted on both sides of the first slider and rollable on both sides of the slide rail, and the second slider has a plurality of pairs of second rollers rotatably mounted on both sides of the second slider and rollable on both sides of the slide rail, the pairs of first rollers allow the first slider to move along the slide rail and the pairs of second rollers allow the second slider to move along the slide rail.

7. The cable core separation system of claim 1, further comprising a support frame and a rotating ring rotatably installed on the support frame, the rotating ring rotates around a central axis of the rotating ring, a front end of the mounting plate is fixed to the rotating ring, the rotating ring and the gripper installed on the mounting plate rotate to different orientations along a circumferential direction of the cable.

8. The cable core separation system of claim 7, wherein the cable has a plurality of core wires each extending along the axial direction of the cable when not separated, each core wire is located at different orientations in the circumferential direction of the cable, the rotating ring rotates the gripper to the different orientations such that the gripper can grip each core wire located at the different orientations.

9. The cable core separation system of claim 7, further comprising a rotation drive mechanism connected to the rotating ring, the rotation drive mechanism drives the rotating ring to rotate around the central axis of the rotating ring, the rotation drive mechanism has a second servo motor, a driving wheel connected to an output shaft of the second servo motor, and a transmission wheel engaged between the driving wheel and the rotating ring, the driving wheel drives the rotating ring to rotate through the transmission wheel when the second servo motor drives the driving wheel to rotate.

10. The cable core separation system of claim 9, wherein the driving wheel and the transmission wheel are gears, and an external gear that meshes with the transmission wheel is formed on an outer circumferential surface of the rotating ring; or the driving wheel and the transmission wheel are friction wheels, the driving wheel is in frictional engagement with the transmission wheel, and the transmission wheel is in frictional engagement with the outer circumferential surface of the rotating ring.

11. The cable core separation system of claim 9, further comprising a fixed seat, and a movable seat installed on the fixed seat in a movable manner, the movable seat is movable along the axial direction of the cable, the support frame and the rotation drive mechanism are installed on the movable seat and move along the axial direction of the cable together with the movable seat.

12. The cable core separation system of claim 11, wherein a horizontal guide rail extending along the axial direction of the cable is fixed on the fixed seat, and a sliding block is fixed on a bottom of the movable seat, the sliding block is slidably engaged with the horizontal guide rail such that the movable seat moves along the horizontal guide rail.

13. The cable core separation system of claim 11, further comprising a horizon drive mechanism installed on the fixed seat and connected to the movable seat, the horizon drive mechanism drives the movable seat to move along the axial direction of the cable.

14. The cable core separation system of claim 13, wherein the horizon drive mechanism has a linear electric cylinder, an actuator of the linear electric cylinder is connected to the movable seat and drives the movable seat to move along the axial direction of the cable.

15. The cable core separation system of claim 13, wherein the horizon drive mechanism has a cylinder, a piston rod of the cylinder is connected to the movable seat and drives the movable seat to move along the axial direction of the cable.

16. The cable core separation system of claim 11, further comprising a cable clamp fixed to the fixed seat, the cable clamp clamps the cable, when the cable is clamped on the cable clamp, the cable is centrally positioned in the rotating ring such that a central axis of the cable coincides with the central axis of the rotating ring.

17. The cable core separation system of claim 16, wherein the gripper is moved relative to the cable along the axial direction of the cable when the movable seat is moved along the axial direction of the cable, such that a gripping position of the gripper in the axial direction is adjusted.

18. The cable core separation system of claim 11, further comprising an imaging device fixed to the mounting plate and directed radially towards an unseparated core wire of the cable, the imaging device captures an image of the unseparated core wire.

19. The cable core separation system of claim 18, further comprising:
a core wire image processing device in communication with the imaging device, the core wire image processing device processes the image of the unseparated core wire captured by the imaging device;
a core wire pose recognition device calculating an orientation of the unseparated core wire in the circumferential direction of the cable and a position of the unseparated core wire in the axial direction of the cable based on the processed image;
a gripping pose calculation device calculating a gripping orientation and a gripping position of the gripper based on the calculated orientation and position of the unseparated core wire; and
a gripper control device controlling a circumferential rotation of the rotating ring, an axial movement of the movable seat, and a movement of the gripper moving device to move the gripper to the gripping orientation and the gripping position.

20. The cable core separation system of claim 19, wherein the gripper grips the unseparated core wire when the gripper is moved to the gripping orientation and the gripping position, and after the gripper grips the unseparated core wire, the gripper control device controls the first slider to move back along the slide rail to bend the gripped core wire from an initial position parallel to the axial direction of the cable to a separation position parallel to the radial direction of the cable through the gripper.
